(19) United States
(12) Patent Application Publication
(10) Pub. No.: US 2010/0191958 A1
(43) Pub. Date: Jul. 29, 2010

(54) METHOD AND NETWORK DEVICE FOR PROCESSING NESTED INTERNET PROTOCOL SECURITY TUNNELS

(75) Inventor: Po-Fei Chen, Taiwan (CN)

Correspondence Address: GREENBLUM & BERNSTEIN, P.L.C., 1950 ROLAND CLARKE PLACE, RESTON, VA, 20191, US

(73) Assignee: PANASONIC CORPORATION, Osaka (JP)

(21) Appl. No.: 12/376,879

(22) PCT Filed: Sep. 27, 2007
(86) PCT No.: PCT/JP2007/069400

§ 371 Date: Feb. 9, 2009

(30) Foreign Application Priority Data
Sep. 29, 2006 (CN) 200610141464.X

(51) Int. Cl. H04L 29/06

(52) U.S. Cl. 713/153

(57) ABSTRACT

A method and network device for processing nested IPSec tunnels are for processing outbound packets flowing into QC and inbound packets flowing out an IPSec tunnel via the network device. The network device (3) includes a network interface unit (31), a Security Association database (32), and an IPSec processing unit (33) including a selective encryption module (331) and a selective decryption module (332). The IPSec processing unit is for generating a new IPSec packet through the selective encryption module for an outbound packet determined to be an IPSec-encrypted packet, and for obtaining a plaintext through the selective decryption module for an inbound packet determined to have undergone processing by the selective encryption module.

### TECHNICAL FIELD

The invention relates to a method and network device for processing Internet Protocol Security (IPSec) tunnels, and more particularly to a method and network device for processing nested IPSec tunnels.

### BACKGROUND ART

In Internet communications, IPSec is widely employed to provide security services to the Internet Protocol layer on a peer-to-peer basis. Through the establishment of an IPSec tunnel between two network devices encrypting packets transmitted therebetween, network transmission between the network devices can be protected. However, between the network devices, other devices, such as gateways, may be present and establish another IPSec tunnel over the original IPSec tunnel, thereby resulting in nested IPSec tunnels.

Referring to FIG. 1, a nested IPSec tunnel is described as an example. A first IPSec tunnel 13 is established between a first terminal 11 and a second terminal 12. Over the first IPSec tunnel 13, there is a second IPSec tunnel 16 established between a first gateway 14 and a second gateway 15.

Packets transmitted between the first terminal 11 and the second terminal 12 pass through the first gateway 14 and the second gateway 15, and are simultaneously encrypted and protected by the first IPSec tunnel 13 and the second IPSec tunnel 16. FIG. 2 shows a packet simultaneously encrypted and protected by the first IPSec tunnel 13 and the second IPSec tunnel 16, where encrypted data 21 is encrypted and protected by the first IPSec tunnel 13 and encrypted data 22 is encrypted and protected by the second IPSec tunnel 16. Repeated encryption of the encrypted data 21 will result in additional burden during its decryption by another network device that receives such packets.

A conventional method of improvement was described in IETF draft of August 2005 entitled “Terminology for Benchmarking IPSec Devices,” and proposed limiting the level of nesting to overcome the problem of nested IPSec tunnels. Taking FIG. 1 as an example, when the first gateway 14 receives a packet from the first terminal 11 and finds that the packet is an IPSec packet, it will not encrypt the IPSec packet. This method of limiting the level of nesting can indeed avoid repeated encryption in nested IPSec tunnels, and reduce additional burden during decryption. However, the IP header 23 and the Encapsulating Security Payload (ESP) header 24 in FIG. 2 are not encrypted and protected, easily leading to security breaches.

Another conventional method of improvement was described in a report of 3GPP TSG SA WG3 Security, November 2000, entitled “Simplifying Assumption for the Use of IPSec in UMTS,” and used chained tunnels to overcome the problem of nested IPSec tunnels. Taking FIG. 1 as an example again, the first gateway 14 first decrypts the encrypted packets from the first terminal 11, and then encrypts the packets. Thereafter, the second gateway 15 decrypts the packets encrypted by the first gateway 14, and then encrypts the packets. In the method of chained tunnels, repeated encryption in nested IPSec tunnels can be avoided. However, each intermediary gateway (such as the first gateway 14 and the second gateway 15) must first decrypt and then encrypt the packets, thereby increasing the processing time of each intermediary gateway.

Therefore, there is a need to find a solution to prevent repeated encryption in nested IPSec tunnels while also considering security and processing time.

### DISCLOSURE OF INVENTION

Therefore, an object of the present invention is to provide a method for processing outbound nested IPSec tunnels, which is adapted to process outbound packets flowing into an IPSec tunnel via a network device, each of the outbound packets containing a header and a payload, the IPSec tunnel having at least one existing Security Association.

Accordingly, the method for processing outbound nested IPSec tunnels of this invention comprises the following steps: (a) for each of the outbound packets, determining if it is an IPSec-encrypted packet; (b) performing selective encryption on each IPSec-encrypted packet to obtain its ciphertext; and (c) generating a new IPSec packet for each IPSec-encrypted packet, whose payload contains the ciphertext and whose header contains an indicating unit for indicating if the packet has undergone selective encryption.

Another object of the present invention is to provide a method for processing inbound nested IPSec tunnels, which is adapted to process inbound packets flowing out of an IPSec tunnel via a network device, each of the inbound packets containing a header and a payload, the IPSec tunnel having at least one existing Security Association.

Accordingly, the method for processing inbound nested IPSec tunnels of this invention comprises the following steps: (a) for each of the inbound packets, determining if it has undergone selective encryption; and (b) performing selective decryption on each inbound packet that has undergone selective encryption to obtain its plaintext.

Yet another object of the present invention is to provide a network device for processing nested IPSec tunnels, which is adapted to process outbound packets flowing into and inbound packets flowing out an IPSec tunnel via the network device, each of the outbound packets and the inbound packets containing a header and a payload.

Accordingly, the network device for processing nested IPSec tunnels of the present invention comprises a network interface unit, a Security Association database, and an IPSec processing unit. The network interface unit is used to receive the outbound packets and the inbound packets. The Security Association database is used to store at least one Security Association that includes an encryption algorithm and a decryption algorithm to be applied on either the outbound packets or the inbound packets. The IPSec processing unit includes a selective encryption module and a selective decryption module. When processing each of the outbound packets, the IPSec processing unit first determines if an outbound packet is an IPSec-encrypted packet. If yes, the outbound packet is processed by the selective encryption module to obtain a ciphertext according to corresponding information in the Security Association database. The IPSec processing unit subsequently generates a new IPSec packet for each IPSec-encrypted packet, whose payload contains the ciphertext, and whose header contains an indicating unit for indicating if the packet has undergone processing by the selective encryption module. When processing each of the inbound packets, the IPSec processing unit first determines if an inbound packet has undergone processing by the selective encryption module. If yes, the inbound packet is processed by the selective decryption module to obtain a plaintext according to corresponding information in the Security Association database.

Through selective encryption and selective decryption in the present invention, repeated encryption in nested IPSec tunnels can be avoided, with security and processing time being also considered, thereby achieving the objects of the present invention.

### BRIEF DESCRIPTION OF DRAWINGS

Other features and advantages of the present invention will become apparent in the following detailed description of the preferred embodiment with reference to the accompanying drawings, of which:

FIG. 1 is a schematic diagram to illustrate an example of a nested IPSec tunnel;

FIG. 2 is a schematic diagram to illustrate a conventional packet that has undergone repeated encryption;

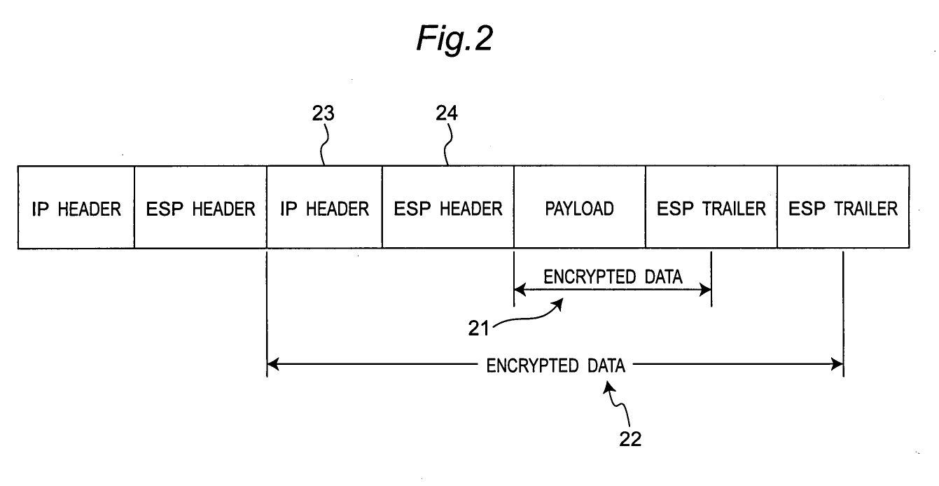

FIG. 3 is a system block diagram to illustrate the preferred embodiment of a network device for processing nested IPSec tunnels according to the present invention;

FIG. 4 is a flowchart to illustrate the preferred embodiment of a method for processing outbound nested IPSec tunnels according to the present invention;

FIG. 5 is a flowchart to illustrate the preferred embodiment of a method for processing inbound nested IPSec tunnels according to the present invention; and

FIG. 6 is a schematic diagram to illustrate a packet that has undergone selective encryption according to the present invention.

### BEST MODE FOR CARRYING OUT THE INVENTION

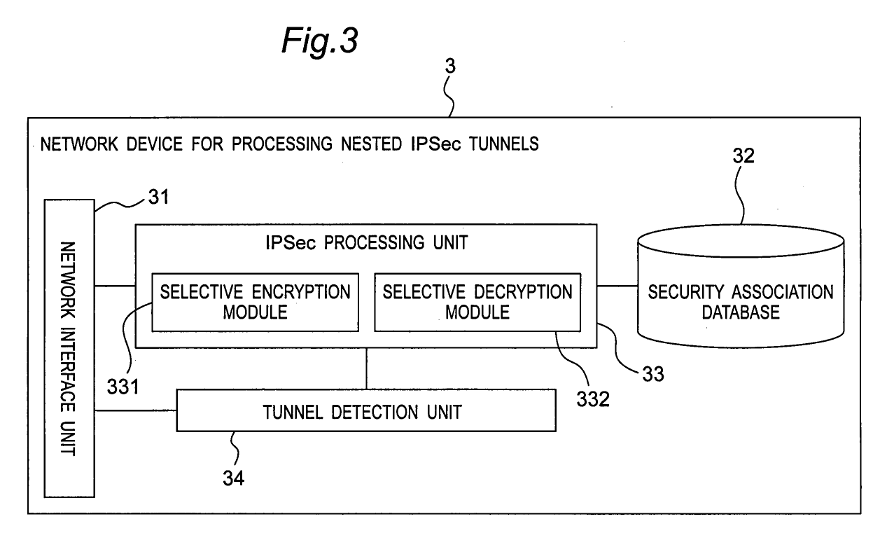

Referring to FIG. 3, the preferred embodiment of a network device 3 for processing nested Internet Protocol Security (IPSec) tunnels according to the present invention is for processing outbound packets flowing into and inbound packets flowing out an IPSec tunnel via the network device 3. Each of the outbound packets and the inbound packets contains a header and a payload. The network device 3 includes a network interface unit 31, a Security Association database 32, an IPSec processing unit 33, and a tunnel detection unit 34. The Security Association database 32 is for storing at least one Security Association (SA) that includes an encryption algorithm and a decryption algorithm to be applied on either the outbound packets or the inbound packets. The IPSec processing unit 33 includes a selective encryption module 331 and a selective decryption module 332. The network device 3 can be a gateway or any similar device.

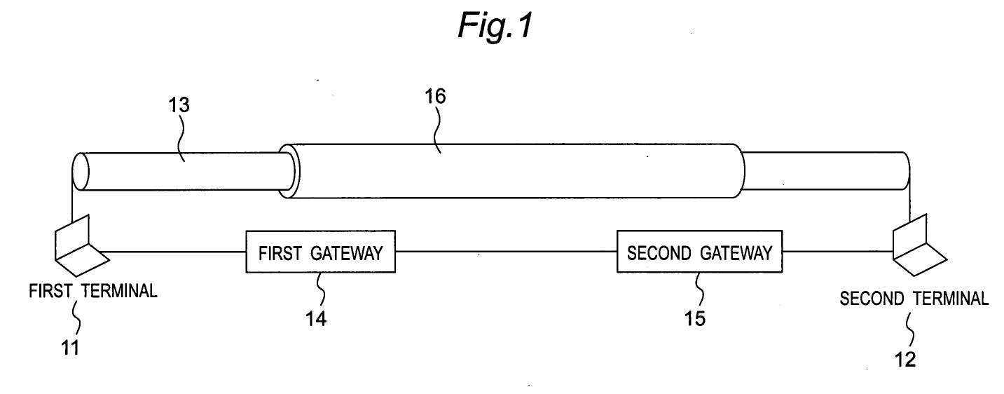

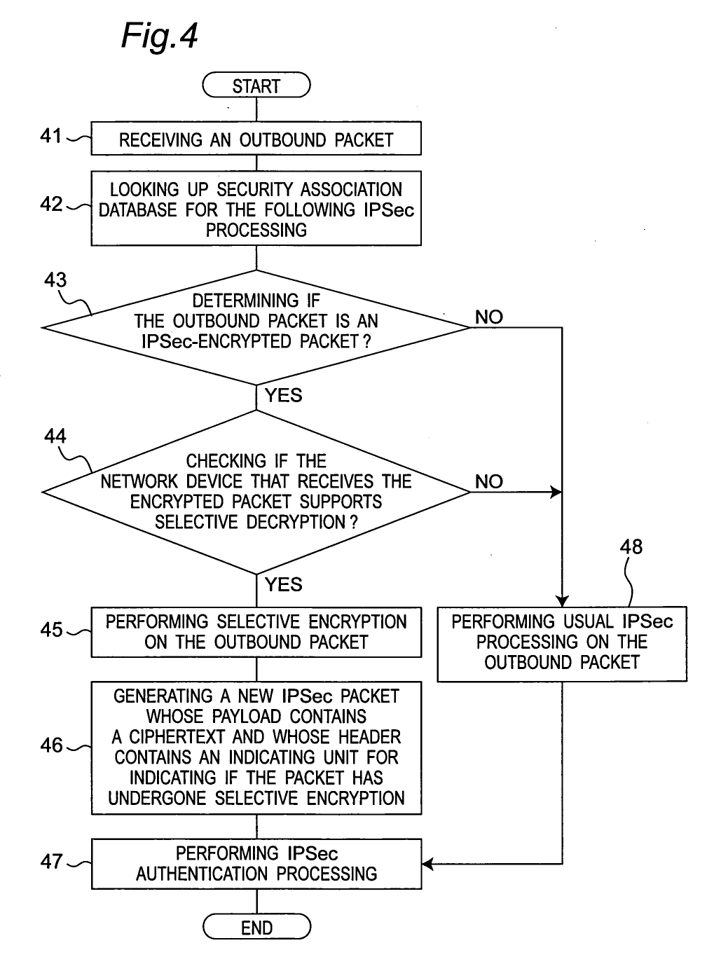

Referring to FIGS. 3 and 4, in combination with the example of FIG. 1, the method for processing outbound nested IPSec tunnels of the present invention is adapted to process outbound packets flowing into an IPSec tunnel (such as the second IPSec tunnel 16 in FIG. 1) via the network device 3 (such as the first gateway 14 in FIG. 1). The method includes the following steps. In step 41, the network interface unit 31 is used to receive the outbound packets.

In step 42, the IPSec processing unit 33 inspects the Security Association database 32 to determine the way of the following IPSec processing commonly used by the communicating parties.

In step 43, the IPSec processing unit 33 inspects the header of each outbound packet to see if there is an ESP header for determining if the outbound packet is an IPSec-encrypted packet. If yes, the flow proceeds to processing in step 44. Otherwise, the flow proceeds to processing in step 48, where the IPSec processing unit 33 performs usual IPSec processing on the outbound packet.

In step 44, according to a pre-negotiated scheme, the tunnel detection unit 34 determines if another network device that receives the outbound packets (such as the second gateway 15 in FIG. 1) supports selective decryption. If affirmative, the flow proceeds to processing in step 45. Otherwise, the flow proceeds to processing in step 48, where the IPSec processing unit 33 performs usual IPSec processing on the outbound packet. As for the pre-negotiated scheme, an inquiry signal can be sent to the other network device, followed by an acknowledge signal (ACK) from the other network device to indicate the support of selective decryption.

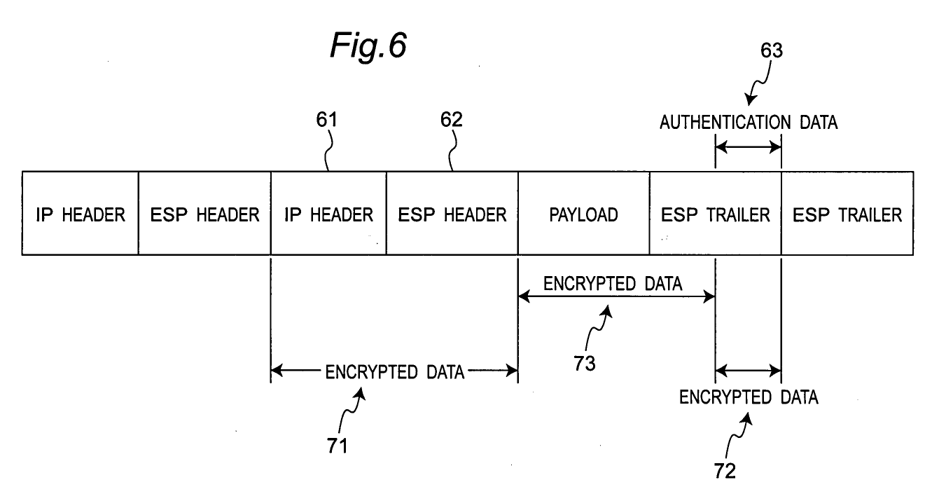

In step 45, the selective encryption module 331 of the IPSec processing unit 33 performs selective encryption on the outbound packet to obtain a ciphertext. The selective encryption is performed according to the encryption algorithm of the SA. As shown in FIG. 6, the selective encryption module 331 can encrypt IP header 61 and ESP header 62 of an inner layer IPSec packet to generate the ciphertext (i.e., encrypted data 71), or IP header 61, ESP header 62 and authentication data 63 of the ESP trailer of an inner layer IPSec packet to generate the ciphertext (i.e., encrypted data 71 plus encrypted data 72).

In step 46, a new IPSec packet (see FIG. 6) is generated. The payload of the new IPSec packet contains the ciphertext and the header of the new IPSec packet contains an indicating unit for indicating if the packet has undergone selective encryption. In this embodiment, the indicating unit includes two bits: one for indicating if the packet has undergone selective encryption, and the other for indicating a processing range of the selective encryption, i.e., encrypted data 71 (see FIG. 6) or encrypted data 71 plus encrypted data 72 (see FIG. 6).

In step 47, the IPSec processing unit 33 performs IPSec authentication processing.

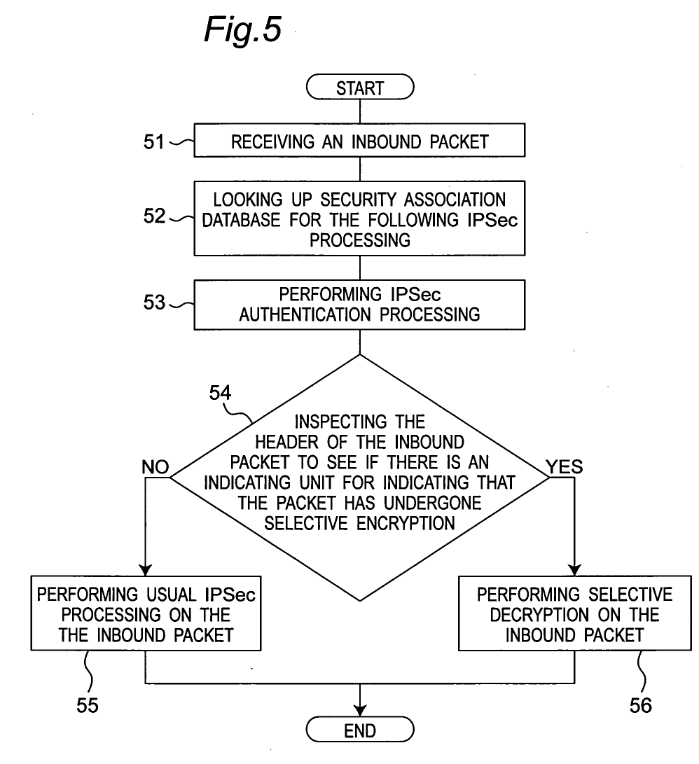

Referring to FIGS. 3 and 5, in combination with the example of FIG. 1, the method for processing inbound nested IPSec tunnels of the present invention is adapted to process inbound packets flowing out of an IPSec tunnel (such as the second IPSec tunnel 16 in FIG. 1) via the network device 3 (such as the second gateway 15 in FIG. 1). The method includes the following steps.

In step 51, the network interface unit 31 is used to receive the inbound packets.

In step 52, the IPSec processing unit 33 inspects the Security

Association database 32 to determine the way of the following IPSec processing.

In step 53, the IPSec processing unit 33 performs IPSec authentication processing.

In step 54, the IPSec processing unit 33 inspects the header of each inbound packet to see if there is an indicating unit for indicating that the packet has undergone selective encryption, so as to determine if the inbound packet has undergone selective encryption. If yes, the flow proceeds to processing in step 56. Otherwise, the flow proceeds to processing in step 55.

In step 55, the IPSec processing unit 34 performs usual IPSec processing on the inbound packet.

In step 56, the selective decryption module 332 of the IPSec processing unit 33 performs selective decryption on the inbound packet to obtain a plaintext. The selective decryption is performed according to the decryption algorithm of the SA. According to the indicating unit, the range of the plaintext can be determined, i.e., encrypted data 71 (see FIG. 6), or encrypted data 71 plus encrypted data 72 (see FIG. 6).

In sum, as shown in FIG. 6, through selective encryption and selective decryption in the present invention, encrypted data 73 of the inner layer IPSec packet will not be repeatedly encrypted, thereby solving the problem of nested IPSec tunnels. In addition, IP header 61 and ESP header 62 are still subjected to encryption and accordingly receive protection, so that there will be less security concerns and stronger security if authentication data 63 can be optionally encrypted as well. Moreover, since the network device 3 selectively encrypts and decrypts outbound/inbound packets, and does not need to perform decryption followed by encryption, processing time can be saved. The objects of the present invention are thus achieved.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

1. A method for processing outbound nested IPSec tunnels adapted to process outbound packets flowing into an IPSec tunnel via a network device, each of the outbound packets containing a header and a payload, the IPSec tunnel having at least one existing Security Association, the method comprising the following steps:
(a) for each of the outbound packets, determining if it is an IPSec-encrypted packet;
(b) performing selective encryption on each IPSec-encrypted packet to obtain its ciphertext; and
(c) generating a new IPSec packet for each IPSec-encrypted packet, whose payload contains the ciphertext and whose header contains an indicating unit for indicating if the packet has undergone selective encryption.

2. The method for processing outbound nested IPSec tunnels as claimed in claim 1, wherein the header of the outbound packet is inspected in step (a) to see if it has an Encapsulating Security Payload header so as to determine if the outbound packet is an IPSec-encrypted packet.

3. The method for processing outbound nested IPSec tunnels as claimed in claim 1, further comprising, between steps (a) and (b):
(d) according to a pre-negotiated scheme, determining whether or not another network device that receives the new IPSec packet supports selective decryption, and proceeding to processing of steps (b) and (c) if affirmative.

4. The method for processing outbound nested IPSec tunnels as claimed in claim 1, wherein selective encryption in step (b) involves encrypting the Internet Protocol header and the Encapsulating Security Payload header of the IPSec-encrypted packet to generate the ciphertext.

5. The method for processing outbound nested IPSec tunnels as claimed in claim 1, wherein selective encryption in step (b) involves encrypting the Internet Protocol header, the Encapsulating Security Payload header, and authentication data of the Encapsulating Security Payload trailer of the IPSec-encrypted packet to generate the ciphertext.

6. The method for processing outbound nested IPSec tunnels as claimed in claim 1, wherein selective encryption in step (b) is conducted according to an encryption algorithm of the Security Association so as to generate the ciphertext.

7. The method for processing outbound nested IPSec tunnels as claimed in claim 1, wherein, in step (c), the indicating unit of the header of the new IPSec packet further indicates a processing range of the selective encryption.

8. A method for processing inbound nested IPSec tunnels adapted to process inbound packets flowing out of an IPSec tunnel via a network device, each of the inbound packets containing a header and a payload, the IPSec tunnel having at least one existing Security Association, the method comprising the following steps:
(a) for each of the inbound packets, determining if it has undergone selective encryption; and
(b) performing selective decryption on each inbound packet that has undergone selective encryption to obtain its plaintext.

9. The method for processing inbound nested IPSec tunnels as claimed in claim 8, wherein the header of the inbound packet is inspected in step (a) to see if there is an indicating unit used to indicate that the inbound packet has undergone selective encryption.

10. The method for processing inbound nested IPSec tunnels as claimed in claim 9, wherein the indicating unit further indicates a processing range of the selective encryption.

11. The method for processing inbound nested IPSec tunnels as claimed in claim 8, wherein the plaintext restored during selective decryption in step (b) includes an Internet Protocol header and an Encapsulating Security Payload header.

12. The method for processing inbound nested IPSec tunnels as claimed in claim 8, wherein the plaintext restored during selective decryption in step (b) includes an Internet Protocol header, an Encapsulating Security Payload header, and authentication data of the Encapsulating Security Payload trailer.

13. The method for processing inbound nested IPSec tunnels as claimed in claim 8, wherein selective decryption in step (b) is conducted according to a decryption algorithm of the Security Association so as to restore the plaintext.

14. A network device for processing nested IPSec tunnels adapted to process outbound packets flowing into and inbound packets flowing out an IPSec tunnel via said network device, each of the outbound packets and the inbound packets containing a header and a payload, said network device comprising:
a network interface unit for receiving the outbound packets and the inbound packets;
a Security Association database for storing at least one Security Association that includes an encryption algorithm and a decryption algorithm; and
an IPSec processing unit including a selective encryption module and a selective decryption module,
wherein, when processing each of the outbound packets, said IPSec processing unit first determines if an outbound packet is an IPSec-encrypted packet, the outbound packet being processed by said selective encryption module to obtain a ciphertext if identified as an IPSec-encrypted packet, said IPSec processing unit subsequently generating a new IPSec packet for each IPSec-encrypted packet, whose payload contains the ciphertext and whose header contains an indicating unit for indicating if the packet has undergone processing by said selective encryption module,
wherein, when processing each of the inbound packets, said IPSec processing unit first determines if an inbound packet has undergone processing by said selective encryption module, the inbound packet being processed by said selective decryption module to obtain a plaintext if the inbound packet has undergone processing by said selective encryption module.

15. The network device for processing nested IPSec tunnels as claimed in claim 14, wherein said IPSec processing unit inspects the header of the outbound packet to see if it has an Encapsulating Security Payload header so as to determine if the outbound packet is an IPSec-encrypted packet.

16. The network device for processing nested IPSec tunnels as claimed in claim 14, further comprising a tunnel detection unit for confirming, according to a pre-negotiated scheme, whether another network device that receives the new IPSec packet has said selective decryption module, and directing the processing of said selective encryption module if affirmative.

17. The network device for processing nested IPSec tunnels as claimed in claim 14, wherein said selective encryption module encrypts the Internet Protocol header and the Encapsulating Security Payload header of the IPSec-encrypted packet to generate the ciphertext.

18. The network device for processing nested IPSec tunnels as claimed in claim 14, wherein said selective encryption module encrypts the Internet Protocol header, the Encapsulating Security Payload header, and authentication data of the Encapsulating Security Payload trailer of the IPSec-encrypted packet to generate the ciphertext.

19. The network device for processing nested IPSec tunnels as claimed in claim 14, wherein said selective encryption module generates the ciphertext according to the encryption algorithm of the Security Association.

20. The network device for processing nested IPSec tunnels as claimed in claim 14, wherein the indicating unit of the header of the new IPSec packet further indicates a processing range of said selective encryption module.

21. The network device for processing nested IPSec tunnels as claimed in claim 14, wherein said IPSec processing unit inspects the header of the inbound packet to see if there is the indicating unit used to indicate that the inbound packet has undergone processing by said selective encryption module.

22. The network device for processing nested IPSec tunnels as claimed in claim 21, wherein the indicating unit of the header of the inbound packet further indicates a processing range of said selective encryption module.

23. The network device for processing nested IPSec tunnels as claimed in claim 14, further comprising a tunnel detection unit for notifying, according to a pre-negotiated scheme, another network device whether or not said selective decryption module is supported.

24. The network device for processing nested IPSec tunnels as claimed in claim 14, wherein the plaintext restored by said selective decryption module includes an Internet Protocol header and an Encapsulating Security Payload header.

25. The network device for processing nested IPSec tunnels as claimed in claim 14, wherein the plaintext restored by said selective decryption module includes an Internet Protocol header, an Encapsulating Security Payload header, and authentication data of the Encapsulating Security Payload trailer.

26. The network device for processing nested IPSec tunnels as claimed in claim 14, wherein said selective decryption module restores the plaintext according to the decryption algorithm of the Security Association.
